(19) United States
(12) Patent Application Publication
(10) Pub. No.: US 2009/0144138 A1
(43) Pub. Date: Jun. 4, 2009

(54) Method and system of advertisement management

(75) Inventor: Jagadeshwar R. Nomula, Sunnyvale, CA (US)

Correspondence Address: Yahoo! Inc., c/o Kenyon & Kenyon LLP, 333 W. San Carlos Street, Suite 600, San Jose, CA, 95110, US

(73) Assignee: Yahoo! Inc., Sunnyvale, CA (US)

(21) Appl. No.: 11/947,715

(22) Filed: Nov. 29, 2007

(51) Int. Cl. G06Q 30/00

(52) U.S. Cl. 705/14

(57) ABSTRACT

A system and method which may allow advertisers to distinguish new users and repeaters, and reduce advertisement costs on repeaters accordingly. The system may include a request/response server, a user resolving server and a policy server. The request/response server may receive a request for viewing a publisher website by a user and obtain from request cookies the user's identity information. With the user's identity information, the user resolving server may decide whether the user has previously been shown an advertiser's advertisement to be displayed on the requested website. The policy server may then access the policy of the advertiser and indicate whether it is favorable to show to the user the advertiser's advertisement on the requested website.

### BACKGROUND

1. Field of the Invention

The present invention relates generally to online advertising, and more particularly to a method for managing advertisement cost.

2. Description of Related Art

With the growth of the Internet, online advertising is becoming more and more important for advertisers (buyers of advertisement spaces, e.g., Coca Cola™ and Nike™). Typically, an advertiser may pay an advertisement network a certain amount of money for a certain number of impressions, spread among any number of users. The advertisement network may put the advertiser's advertisement on different web site publishers (websites selling advertisement space, e.g., www.vahoo.com, and www.cnn.com).

An advertiser may evaluate results by the number of impressions. However, such an evaluation may be inaccurate, since the advertiser may not receive any information about how many of the impressions are shown to new users (anybody browsing a website), and how many of the impressions are shown to repeat users. For example, an advertiser may have paid an advertisement network for 1000 impressions, and the advertisement network may have displayed the advertiser's advertisement 600 times on www.BusinessWeek.com, and 400 times on www.cnn.com. The fewer the users being shown the advertisement on both websites, the better the result. But the currently available systems cannot tell how many impressions are shown to repeat users (repeaters), and thus may not be very helpful to advertisers resulting determining results.

In addition, since the currently available systems do not provide advertisers with information about who is a new user and who is a repeater, the advertiser may not know whether a user has been shown its advertisement on a first website, e.g., www.BusinessWeek.com, and cannot control whether to show to the user its advertisement on a second website, e.g., www.cnn.com. Consequently, advertisers may waste their money on repeaters by showing the same advertisement to the same user on different web sites.

An advertisement exchange may allow advertisers to bid for advertisement spaces on various websites in real time. This may help advertisers to better control their advertisement costs. However, without information about who is a new user and who is a repeater, advertisers cannot adjust their bidding rates accordingly, and may still overspend on repeaters.

Therefore, it may be desirable to provide a system and method which may help advertisers to manage their advertising costs more effectively by avoiding showing the same advertisement multiple times to different users.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates an exemplary environment in which an advertisement management system of the present invention may be used.

FIG. 2 illustrates an advertisement management system according to one embodiment of the present invention, used in the exemplary environment shown in FIG. 1.

FIGS. 3A and 3B illustrate a flow chart of an advertisement management method according to one embodiment of the present invention.

### DETAILED DESCRIPTION

The present invention provides a system and method which may allow advertisers to distinguish new users from repeaters, and reduce advertisement costs accordingly. In one embodiment, the system may include a request/response server, a resolving server and a policy server. The request/response server may receive a user request for viewing a publisher website. An advertiser's advertisement is to be shown on the requested website. The request/response server may obtain, e.g., a user IP address, name, geographic location, and/or age. With this information, the resolving server may decide whether the user has previously been shown the advertiser's advertisement. The policy server may then access the policy of the advertiser and indicate whether to show to the user the advertiser's advertisement on the requested website. The system of the present invention may indicate to an advertiser that a user has been shown its advertisement on a first website, so the advertiser may control whether to show to the same user the advertisement on a second website. Consequently, the advertiser may avoid spending money on showing the same advertisement to repeaters; may display its advertisement to more users within the same number of impressions; and may use advertising costs more effectively. Advantages of the present invention will become apparent from the following detailed description.

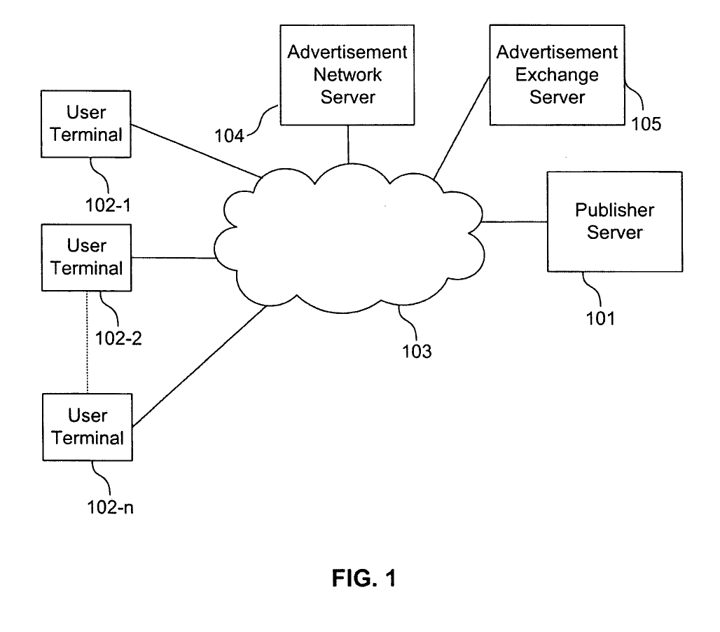

FIG. 1 illustrates an exemplary environment in which an advertisement management system of the present invention may be used. As shown, a publisher server 101 may communicate over a network 103 with a number of user terminals 102-1, 102-2, . . . 102-n. The publisher server 101 may be a computer system and may control the operation of a website or a blog. The user terminals 102 may be personal computers, handheld or laptop devices, microprocessor-based systems, set top boxes, or programmable consumer electronics. Each user terminal may have a browser application configured to receive and display web pages, which may include text, graphics, multimedia, etc. The web pages may be based on, e.g., HyperText Markup Language (HTML) or extensible markup language (XML). One or more advertisements may be displayed on a web page. Network connectivity may be wired or wireless, using one or more communications protocols, as will be known to those of ordinary skill in the art.

An advertisement network server 104 and/or advertisement exchange server 105 may be coupled to the network 103 to send advertisements to publisher servers according to agreements between publishers, advertisers and the advertisement network or advertisement exchange. As mentioned above, the agreement may be, e.g., that the advertisement network or advertisement exchange should display an advertiser's advertisement on certain websites for a certain number of impressions, in return for a certain amount of money from the advertiser.

It should be understood that 101, 104 and 105 are representative of publisher servers, advertisement network servers and advertisement exchange servers, and that the system shown in FIG. 1 may have any number of such servers.

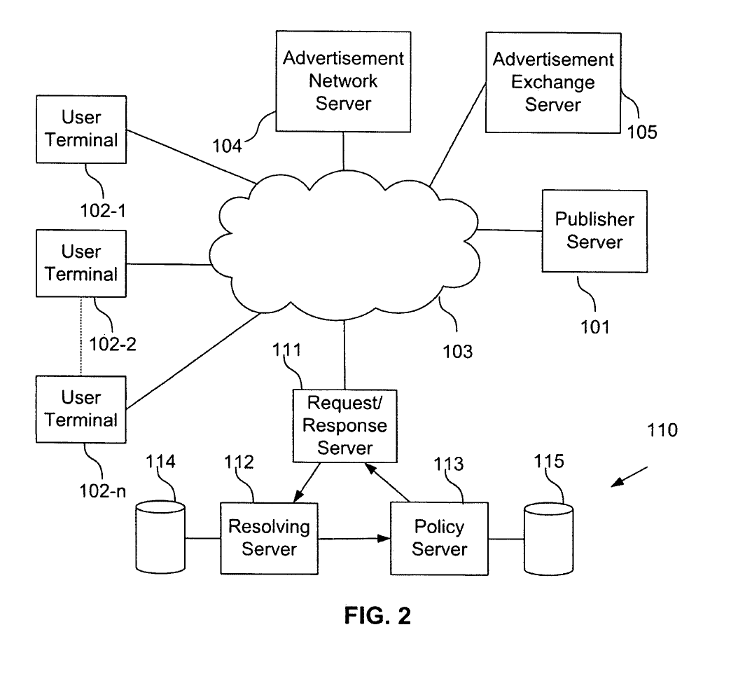

FIG. 2 illustrates an advertisement management system according to one embodiment of the present invention, used in the exemplary environment shown in FIG. 1. As shown, an advertisement management system 110 of the present invention may be coupled to the network 103 and communicate with publisher servers 101, user terminals 102, and advertisement network servers 104 and/or advertisement exchange servers 105.

The advertisement management system 110 may have a request/response server 111, a user resolving server 112, a policy server 113, a user information database 114 and a policy database 115.

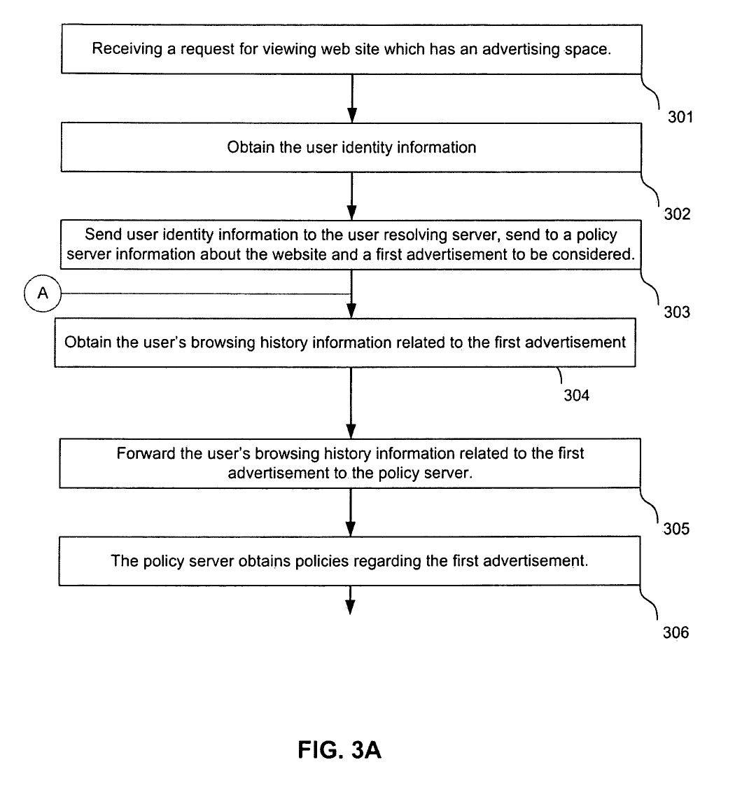

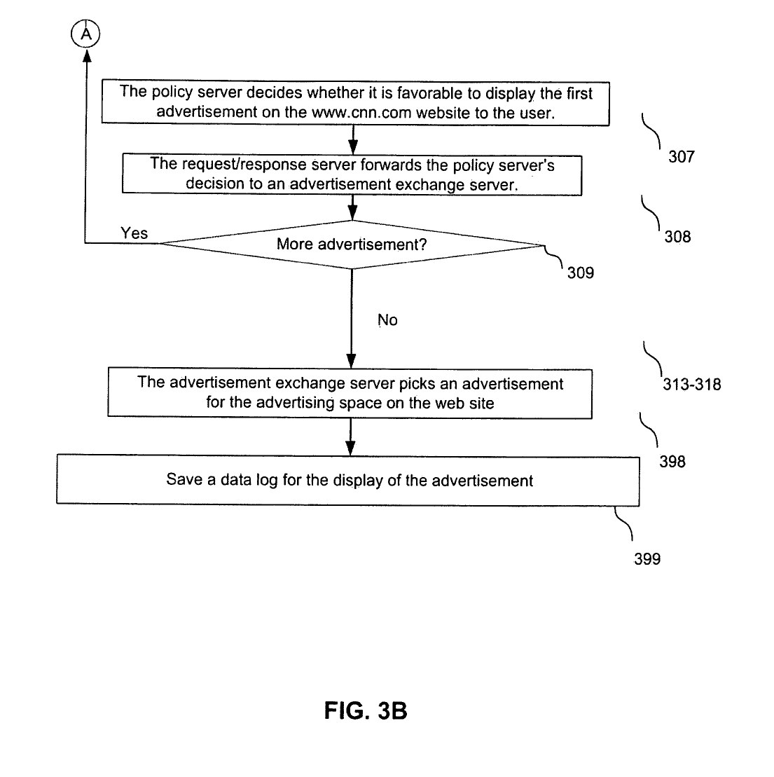

Each of the servers 111, 112 and 113 may be a computer system, which may include one or more of a screen, an input device, a processing unit, a system memory, and a system bus coupling various components in the computer system. The servers 111, 112 and 113 may control processes related to advertisement management, including but not limited to those described below with reference to FIGS. 3A and 3B. Although FIG. 2 shows three separate servers 111, 112 and 113, it should be understood that these servers may be integrated into one server.

When a user asks to view a publisher website, e.g., www.cnn.com, the request/response server 111 may receive a request from a publisher server 101, an advertisement network server 104 or an advertisement exchange server 105. The request may have user related cookies. The request/response server 111 may then obtain user information from the cookies, such as the IP address of the user terminal and the geographic location of the user. If the user is a registered user, the server 111 may also obtain the user's first and last name, interested areas, age, and/or gender. The request/response server 111 may forward some or all of the above-mentioned user information to the user resolving server 112.

The request/response server 111 may obtain from the publisher server 101, the advertisement network server 104, or the advertisement exchange server 105, information about the requested website and the advertisement to be shown on the requested website. In one example, the advertisement is for running shoes. The request/response server 111 may forward information about the requested website and the advertisement to the policy server 113 through the user resolving server 112, or to the policy server 113 directly.

The request/response server 111 may receive from the policy server 113 whether to display the running shoes advertisement to the user on the www.cnn.com website, and return a response to the publisher server, the advertisement network server or the advertisement exchange server from which the request/response server 111 received the request.

When the publisher website requested by the user, www.cnn.com, is displayed, the request/response server 111 may obtain information about the advertisement actually displayed. The server 111 may then store the user's identity information, the website, the advertisement actually displayed and the time the advertisement is displayed as user advertisement related browsing history into the user information database 114.

The user resolving server 112 may receive user information from the request/response server 111. The user information may include, e.g., the user's identity information, geographic location and/or demographic information. The user resolving server 112 may use the user identity information to search the user information database 114 to find out whether the user has previously been shown the running shoes advertisement and send such information to the policy server 113. The user identity information may be his IP address if the user is not registered, his name if the user has logged in, his user ID or any unique attributes which may identify the user.

The user information database 114 may store user information, e.g., the user's identity information, interested areas, geographic location, demographic information and advertisement related browsing history. The user's advertisement related browsing history may include: the advertisements, the publisher website for each of the advertisements and the time the user visited each of the publisher websites, etc. In one embodiment, the user browsing history may include: user name, running shoes advertisement, on www.vahoo.com website, at 4:30 pm on Nov. 2, 2007. In one embodiment, the user's advertisement related browsing history may be stored in the user information database 114 as data logs.

The policy database 115 may store policies of various advertisers. The advertisers may use the policies to target their advertisements on certain groups of users. For example, an advertiser of cosmetic products may want to display the advertisement if a user is a female and has not been shown the advertisement for a week. An advertiser for beer may want to display the advertisement if a user is over 21, lives in California, and has not been shown the advertisement for two days. The policy of an advertiser for running shoes may want to display the advertisement if a user has not been shown the advertisement for a day, etc. An advertiser's policy may also be: do not show the advertisement to a repeater, do not show the advertisement to any user more than five times, etc.

In one embodiment, the policy may be weighted. For example, a running shoes advertiser may: use a number greater than one to indicate that it is very interested in displaying the advertisement if a user has hot been shown the advertisement for two days, use the number one to indicate that it is interested in displaying the advertisement if a user has not been shown the advertisement for a day, use a number less than one to indicate that it is not very interested in displaying the advertisement if a user has not been shown the advertisement for 12 hours, etc. A weighted policy may help an advertiser to adjust its bid for an advertisement space on a website. For example, the advertiser's standard bid may be $0.1/impression, its bid for displaying its advertisement to a user on the advertisement space may be $0.12 if the user has not been shown the advertisement for a relatively long time (e.g. three days), and may be $0.08 if the user was shown the advertisement too recently (e.g. 16 hours ago).

The policy server 113 may receive the user's browsing history related to the running shoes advertisement from the user resolving server 112, e.g., user, running shoes advertisement, on www.vahoo.com website, at 4:30 pm on Nov. 2, 2007. The policy server 113 may receive other user information from the user resolving server 112, e.g., the user's geographic location, the user's demographic information, etc. The policy server 113 may further receive, for example from the request/response server 111 or the user resolving server 112, information about the advertisement to be shown on the publisher website requested by the user, e.g., the running shoes advertisement.

The policy server 113 may access the policy database 115 for the policy of the advertiser about the advertisement to be shown, e.g., positive about displaying the advertisement if a user has not been shown the advertisement for a day. The policy server 113 may compare the user's browsing history related to the running shoes advertisement with the policy to decide whether to display the running shoes advertisement on the website requested by the user, www.cnn.com, and forward the result to the request/response server 111. In one embodiment, the policy server 113 may further consider the user's geographic location and demographic information before making the decision if the policy involves such information.

FIGS. 3A and 3B illustrate a flow chart of an advertisement management method according to one embodiment of the present invention.

At 301, the request/response server 111 may receive a request from an advertisement exchange server 105, indicating that the user wants to view the website www.cnn.com. In one embodiment, the website www.cnn.com may have an advertisement space, and an advertisement for running shoes, a soda advertisement, and a cosmetics advertisement may compete for the advertising space.

At 302, the request/response server 111 may obtain the user information from the request cookies. In one embodiment, the user is logged in, and his user information may include: user, California, age, gender.

At 303, the request/response server 111 may forward the user information to the user resolving server 112. In one embodiment, at 303, the request/response server 111 may inform the policy server 113, either directly or through the user resolving server 112, that the requested website is www.cnn.com and one of the possible advertisements to be considered is the running shoes advertisement.

At 304, the user resolving server 112 may use the user identity information to search the user information database 114 for the user's browsing history related to the running shoes advertisement.

At 305, the user resolving server 112 may forward the user's browsing history related to the running shoes advertisement to the policy server 113. Such information may be, for example, user, running shoes advertisement, on www.vahoo.com website, at 4:30 pm on Nov. 2, 2007.

At 306, the policy server 113 may access the policy database 115 for policies regarding the running shoes advertisement. In one embodiment, the policy may include: $0.12/impression if a user has not been shown the advertisement for two days, $0.1/impression if a user has not been shown the advertisement for a day, $0.08/impression if a user has not been shown the advertisement for 12 hours.

At 307, the policy server 113 may compare the user's browsing history related to the running shoes advertisement with the policy regarding the running shoes advertisement. In one embodiment, the user was shown the running shoes advertisement 16 hours ago, the policy server 113 may indicate: $0.08/impression for displaying the running shoes advertisement on the www.cnn.com website.

At 308, the request/response server 111 may forward the policy server 113's decision to the advertisement exchange server 105 from which the request for viewing the www.cnn.com is received.

At 309, it may be determined whether there is another advertiser interested in the advertisement space on the www.cnn.com website. If yes, 303-308 may repeat for the second advertisement, e.g., the soda advertisement, at 313-318. In one embodiment, the policy for the soda advertisement may be: $0.11/impression if it has not been shown to a user for a day, and the user's browsing history related to the soda advertisement may indicate that the user has not been shown the advertisement for two days. Consequently, the output of the policy server 113 may be: $0.11/impression for displaying the soda advertisement on the www.cnn.com website to the user.

At 319, it may be determined whether there is another advertiser interested in the advertisement space on the www.cnn.com website. If yes, 303-308 may repeat for the third advertisement, e.g., the cosmetics advertisement, at 323-328. In one embodiment, the policy for the cosmetics advertisement may want to display the advertisement if a user is a female and has not been shown the advertisement for a week. Since the user information indicates that the user is not a female, the cosmetics advertisement will not be displayed on the www.cnn.com website to the user.

303-308 may repeat until the policy server 113 makes a decision about all advertisements which might be put on the advertising place on the www.cnn.com.

At 398, the advertisement exchange server 105, which is not a part of the present invention, may pick the advertisement with the highest bid and display it on the www.cnn.com website.

At 399, a data log may be saved in the user information database 114 for the display of the advertisement. The data log may be, e.g., user, soda, on www.cnn.com website, at 8:30 am on Nov. 3, 2007.

As shown, since the advertisement management system of the present invention may indicate whether a user is a repeater, it may help advertisers to save advertising costs on repeaters.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. An advertisement management system, comprising:
a first processing unit, receiving a request for viewing a first website and obtaining identity information from the request, wherein a first advertisement is to be displayed on the first website;
a second processing unit, receiving the identity information from the first processing unit and obtaining a browsing history of a requester for the first website; and
a third processing unit, receiving the user's browsing history regarding the first advertisement and determining whether to display the first advertisement on the first website, or whether to display a second, different advertisement on the first website.

2. The system of claim 1, further comprising: an information database for storing browsing history information.

3. The system of claim 1, further comprising: a policy database for storing at least one advertiser's advertising policy.

4. The system of claim 3, wherein the third processing unit further obtains an advertising policy about the first advertisement from the policy database and compares the advertising policy about the first advertisement with the browsing history regarding the first advertisement.

5. The system of claim 1, wherein the third processing unit uses a number to indicate whether to display the first advertisement on the first website to the user.

6. The system of claim 1, wherein the identity information is an IP address.

7. The system of claim 1, wherein the third processing unit further receives information about geographic location from the first processing unit.

8. The system of claim 1, wherein the third processing unit further receives demographic information from the first processing unit.

9. The system of claim 1, wherein the third processing unit forwards its decision to the first processing unit.

10. The system of claim 2, wherein the first processing unit further receives information about advertisements on a website that has been visited and saves it in the information database as browsing history information.

11. The system of claim 4, wherein, in order to determine whether to display the first or the second advertisement, the third processing unit reviews the browsing history and the policy underlying the first and the second advertisement, and determines whether to display the first or the second advertisement.

12. A method for managing advertising, comprising:
receiving a request for viewing a first website, wherein a first advertisement is to be displayed on the first website;
obtaining a browsing history related to the first advertisement;
comparing the browsing history related to the first advertisement with a policy about the first advertisement; and
determining whether to display the first advertisement on the first website, or whether to display a second, different website.

13. The method of claim 12, further comprising: obtaining identity information from the request.

14. The method of claim 13, further comprising: searching an information database with the identity information to obtain the browsing history related to the first advertisement.

15. The method of claim 12, further comprising: searching a policy database for the policy about the first advertisement.

16. The method of claim 12, wherein the browsing history related to the first advertisement indicates whether the first advertisement has been displayed.

17. The method of claim 12, wherein the browsing history related to the first advertisement indicates when the first advertisement was displayed.

18. The method of claim 12, further comprising: obtaining demographic information.

19. The method of claim 18, further comprising: responsive to the demographic information displaying the first advertisement on the first website.

20. The method of claim 12, further comprising: obtaining geographic location information.

21. The method of claim 20, further comprising: responsive to the geographic location, displaying the first advertisement on the first website.
